(19) United States
(12) Patent Application Publication
(10) Pub. No.: US 2009/0138201 A1
(43) Pub. Date: May 28, 2009

(54) Method For Operating a Vehicle Having A Collision Avoidance System And Device For Carrying Out Such A Method

(75) Inventors: Lutz Eckstein, Stuttgart (DE); Uli Kolbe, Stuttgart (DE); Alfred Lotter, Grafenau (DE); Markus Raab, Kirchardt (DE); Andreas Spieker, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 11/667,589

(22) PCT Filed: Nov. 5, 2005
(86) PCT No.: PCT/EP2005/011859

§ 371 Date: Feb. 3, 2009

(30) Foreign Application Priority Data
Nov. 12, 2004 (DE) 10 2004 054 720.3

(51) Int. Cl. B60W 30/08

(52) U.S. Cl. 701/301

(57) ABSTRACT

A method for operating a vehicle having a collision avoidance system including a sensor for sensing potential other parties to a collision and having an evaluator, connected to a control unit, for evaluating a risk of a collision. It is proposed that when the other party to a collision comes relatively close in the lateral direction, an actuator system is activated in order to predefine a setpoint trajectory of the vehicle in order to avoid a lateral collision. In addition, a device for operating the method is provided.

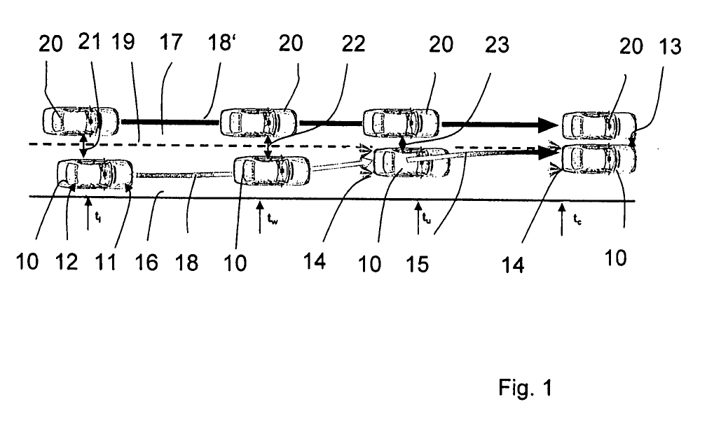

### CROSS REFERENCE TO RELATED APPLICATIONS

This application is a National Stage of PCT International Application No. PCT/EP2005/011859, filed Nov. 5, 2005, which claims priority under 35 U.S.C. § 119 to German Patent Application No. 10 2004 054 720.3 filed Nov. 12, 2004, the entire disclosures of which are herein expressly incorporated by reference.

### BACKGROUND AND SUMMARY OF THE INVENTION

The present invention relates to a method for operating a vehicle having a collision avoidance system and to a device for carrying out such a method.

In the known systems for monitoring a dead angle, objects are sensed in the lateral space to the rear, and, when a risk of collision is imminent a warning signal is emitted. However, a supporting intervention does not occur in this context. Another known type of driver assistance system, referred to as a lane holding assistance system, supports its control process on roadway markings but not on objects with which there is potentially a collision. In addition, the lane holding assistance system generally uses the steering system as an actuator system. Thus, a differentiation between an actuator intervention by the system and a driver's request can be made only with a limited degree of accuracy. In order to avoid removing control from the driver, it is also necessary to know a driver's request precisely to be able to abort the intervention in a vehicle transverse dynamics system in good time. Lane holding assistance systems meet with only a limited degree of acceptance, because each driver of a vehicle prefers a slightly different position on the lane and occasionally also intentionally drives over a boundary line.

German laid-open patent application DE 103 01 790 A1 discloses vehicles having a collision avoidance system for reducing the risk of impact damage. Such devices have a detection device with which a possible impact of the vehicle is detected in advance. When there is the risk of an imminent impact, the detection device emits a signal to a second device which brings about a change in the direction of travel of the vehicle. The known device may serve to avoid and/or alleviate accidents involving rear-end collisions.

The present invention is based on the object of making available an improved method for operating a vehicle having a collision avoidance system and of providing a device for carrying out such a method with which a risk of a collision with a potential other party to a collision is reduced.

This and other objects and advantages are achieved by a method according to the present invention for operating a vehicle having a collision avoidance system. When the other party to a collision comes relatively close in the lateral direction, an actuator system is activated in order to predefine a setpoint trajectory of the vehicle in order to avoid a lateral collision. If the other party to a collision comes relatively close in the lateral direction, either the other party approaches the vehicle or the vehicle approaches the other party or the two parties approach one another. Other parties to a collision can be other vehicles or road users which are located to the side of the vehicle and come relatively close to the vehicle. Other parties to a collision can, however, also be stationary objects, for example, a crash barrier or some other hard roadway boundary such as the walls of a tunnel.

With the method according to the present invention, it is possible to prevent a vehicle driver from overlooking objects to the left or right of his vehicle. In particular, a dead angle region of the vehicle driver can be sensed, for example, at motorway entries or when changing lane. If the lateral distance from objects (e.g., at road works) is incorrectly estimated or if the vehicle driver does not hold his lane for other reasons (e.g., distraction), a risk of a lateral collision with an object can be avoided.

Radar sensors, for example, can be used as means for sensing potential other parties to a collision. In order to detect objects, it is possible, for example, to use 24 GHz radar sensors. 77 GHz radars can be used for predictive or retrospective sensing of the surroundings in order also to include a risk of a potential collision with objects which are further away and are at high relative speeds, such as when there is moving oncoming traffic. The detection and evaluation of potential other parties to a collision can expediently be supported by an additional sensor system, for example, by an image processing system, which also permits objects to be assigned to lanes. As a result, in the case of a multi-lane roadway it is possible to detect the lane on which the object is moving. The system advantageously reacts only to potential other parties to a collision but not to roadway markings.

In the method according to the present invention, the setpoint trajectory may be implemented by a braking intervention at wheel brakes. At low driving speeds, the wheel brakes may be selectively actuated with low braking pressures. In this context the vehicle can advantageously already be steered from a relatively low driving speed by changing the yaw angle of the vehicle. Such an intervention may be unpleasant for the vehicle driver, but because the function is primarily a safety function, the requirements made of the comfort of such an intervention are only of secondary importance.

A vehicle steering system can also be actuated as the actuator system, in particular by the torque adjustor and/or angle adjustor. However, the actuation of the vehicle brakes may be given priority over the actuation of the vehicle steering system without precluding it. If the wheel brakes are used as an actuator system, it is possible to avoid the problem of differentiating between a driver's request and the actuator system of the vehicle steering system when an active steering intervention occurs. This is significant if the steering intervention has to be aborted under certain circumstances. If, in fact, the action which triggers the critical approaching maneuver originates from another road user, the vehicle driver can intuitively abort the system intervention with the steering wheel.

A suspension system can also be actuated as an actuator system in order to actively influence a wheel load distribution. This can be done, for example, by actively changing the rolling torque support, which can be implemented, for example, using a pneumatic suspension system or an active chassis such as ABC (Active Body Control). In this context, corresponding side forces build up on a front axle and rear axle of the vehicle and lead to a transverse movement of the vehicle. This actuator system is effective, in particular, at relatively high vehicle speeds and permits the vehicle to be controlled without appreciably converting kinetic energy into heat.

The intervention by the actuator system can be aborted by an intervention by the vehicle driver. The vehicle driver can switch off the actuator system at any time he wishes, using the steering wheel, for example. This avoids taking control away from the vehicle driver. This requires precise knowledge of the driver's request in order to be able to abort the intervention in the vehicle transverse dynamics in good time.

An intervention time of the actuator system can be determined predominantly as a function of a lateral relative speed, with other factors, for example, the lateral position with respect to the potential other party to a collision, also playing a role. The objective of the system intervention itself is to avert a lateral collision just before the possible collision time. This system intervention can act on the driver himself like a magnetic repulsion which stops as soon as the speed of the relative lateral approach drops below a predetermined threshold value. If this threshold value is defined as zero, it would be possible to avoid a collision but there would still be a risk of a potential collision. For this reason, a minimum distance from the potential other party to a collision can advantageously be defined in order to define the intervention time.

A negative lateral approach speed of the potential other party to a collision can be selected as a threshold value for defining the intervention time in order to be able to preclude a small disruption, nevertheless leading to a lateral collision.

An information function and/or warning function, for example, in the form of visual and/or audible and/or haptic warning signals, can favorably be activated before the intervention time of the actuator system. An illuminated or visual signal, for example, in the region of an exterior rear view mirror, can be emitted as an information device. Virtually any type of audible warning can be issued as an additional or alternative support.

A haptic signal, for which the steering wheel and/or the brake pedal or accelerator pedal can be used, can be emitted as an information device. For this purpose, the steering wheel and/or the corresponding pedal are made to move in a pulsating fashion, as a result of which the vehicle driver is alerted to an imminent hazard situation. It is also possible to provide for the haptic warning signal to be issued via the driver's seat.

A passive safety function is advantageously activated at the intervention time of the actuator system. It is possible to provide, for example, that when one of the aforesaid threshold values is exceeded a side air bag is made more sensitive or reversible upholstered elements are activated. In this context, it is necessary to ensure that the vehicle driver is not disrupted by these safety functions and the driver's behavior is not adversely affected.

The present invention also relates to a device for carrying out a method for operating a vehicle having a collision avoidance system including a sensor for sensing potential other parties to a collision and having evaluators which are connected to a control unit and have the purpose of evaluating a risk of a collision. When the other party to a collision comes relatively close in the lateral direction, an actuator system can be activated in order to predefine a setpoint trajectory in order to avoid a lateral collision.

In the text which follows, the invention will be explained in more detail with reference to an exemplary embodiment described in the drawing. The drawing, the description and the claims contain numerous features in combination, which a person skilled in the art will expediently also consider individually and combine to form further appropriate combinations.

### BRIEF DESCRIPTION OF THE DRAWING

The single FIGURE schematically shows the mode of operation of the method according to the invention.

### DETAILED DESCRIPTION OF THE DRAWING

In the FIGURE, the spatial positions of a vehicle 10 which is equipped with a device according to the invention and is approaching a potential other party 20 to a collision in the direction 18 of travel are shown at the times tᵢ, t_{w}, tᵤ and t_{c}. The potential other party 20 to a collision is a second vehicle which is moving in approximately the same direction 18′ of travel at the same level as the vehicle 10, with the vehicle 10 being located on a first lane 16 and the potential other party 20 to a collision being located on a second lane 17. The lanes 16 and 17 are separated by a roadway boundary line 19. The potential other party 20 to a collision maintains a first lateral distance 21 from the vehicle 10 at the time tᵢ.

The vehicle 10 is equipped with a collision avoidance system which includes sensor 11 (not illustrated in more detail) for sensing the potential other party 20 to a collision and evaluator 12 which is connected to a control unit (not illustrated) and has the purpose of evaluating a risk of a collision. At the position t_{w}, the other party 20 to a collision comes relatively close in the lateral direction as a result of the vehicle 10 moving in the direction of the roadway boundary line 19 and the first lateral distance 21 between the other party 20 to a collision and the vehicle 10 becomes continuously smaller at the time tᵢ, is reduced to a smaller, second lateral distance 22 at the time t_{w} and to an even smaller, third lateral distance 23 at the time tᵤ. Because the vehicle 10 and the other party 20 to a collision come relatively close to one another in the lateral direction, an actuator system is activated in order to predefine a setpoint trajectory 15 for the vehicle 10 in order to avoid a lateral collision with the other party 20 to a collision.

The setpoint trajectory 15 can be implemented by a braking intervention at wheel brakes. In the process, the wheel brakes are actuated selectively with low braking pressures at low driving speeds. A vehicle steering system and/or a vehicle suspension system can also be actively influenced as an actuator system.

The actuator system can be aborted at any time by an intervention by the vehicle driver, such as via the steering system. The vehicle driver can thus intuitively and ultimately decide at any time to actively switch off the system intervention. For this reason, control is not taken away from the vehicle driver in any way by the method according to the invention. The actuation of the vehicle brakes is given priority over the actuation of the vehicle steering system, because the vehicle driver intuitively reacts via the steering system in order to switch off the system intervention. By using the wheel brakes as an actuator system, it is thus possible to differentiate more easily whether the active steering intervention is a driver's request or a system intervention.

An intervention time of the actuator system is determined as a function of a lateral relative speed. The objective of the system intervention itself is to avert a lateral collision just before the possible collision time. This system intervention acts on the driver himself like a magnetic repulsion which stops as soon as the speed of the relative lateral approach drops below a predetermined threshold value. A minimum distance 13 from the potential other party 20 to a collision is predefined in the FIGURE for this threshold value for defining the intervention time. A negative lateral approach speed of the potential other party 20 to a collision can also be selected as a threshold value for defining the intervention time.

An information function and/or warning function 14 can be activated before the intervention time of the actuator system. In the FIGURE, this is done in the form of a flashing hazard warning light. At the intervention time of the actuator system, it is possible to activate at least one passive safety function, during which, for example, the triggering of a side air bag is made more sensitive.

With the device and method for operating the device according to the invention, it is possible to reduce significantly the number of accidents, in particular when changing lanes, at motorway entries and when traveling through road works.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-13. (canceled)

14. A method for operating a vehicle having a collision avoidance system including a sensor for sensing a potential other party to a collision and having an evaluator, connected to a control unit, for evaluating a risk of a collision,
wherein, when the other party to a collision comes relatively close in a lateral direction, an actuator system is activated to predefine a setpoint trajectory of the vehicle to avoid a lateral collision.

15. The method as claimed in claim 14, wherein the setpoint trajectory is implemented by a braking intervention at wheel brakes.

16. The method as claimed in claim 15, wherein at low driving speeds the wheel brakes are selectively actuated with low braking pressures.

17. The method as claimed in claim 15, wherein the setpoint trajectory is further implemented by actuating a vehicle steering system.

18. The method as claimed in claim 17, wherein actuation of the wheel brakes is given priority over actuation of the vehicle steering system.

19. The method as claimed in claim 14, wherein at least one of a vehicle suspension system and a suspension system for actively influencing a wheel load distribution is actuated.

20. The method as claimed in claim 14, wherein at least one of an activation of the actuator system and an intervention by the actuator system is aborted by an intervention by the vehicle driver.

21. The method as claimed in claim 14, wherein an intervention time of the actuator system is determined as a function of a lateral relative speed.

22. The method as claimed in claim 21, wherein, in order to define the intervention time, a minimum distance from the potential other party to a collision is defined.

23. The method as claimed in claim 21, wherein a negative lateral approach speed of the potential other party to a collision is selected as a threshold value for defining the intervention time.

24. The method as claimed in claim 21, wherein at least one of an information function and a warning function is activated before the intervention time of the actuator system.

25. The method as claimed in claim 21, wherein at least one passive safety function is activated at the intervention time of the actuator system.

26. The method as claimed in claim 15, wherein at least one of a vehicle suspension system and a suspension system for actively influencing a wheel load distribution is actuated.

27. The method as claimed in claim 15, wherein at least one of the activation of the actuator system and an intervention by the actuator system is aborted by an intervention by the vehicle driver.

28. The method as claimed in claim 15, wherein an intervention time of the actuator system is determined as a function of a lateral relative speed.

29. The method as claimed in claim 22, wherein a negative lateral approach speed of the potential other party to a collision is selected as a threshold value for defining the intervention time.

30. The method as claimed in claim 22, wherein at least one of an information function and a warning function is activated before the intervention time of the actuator system.

31. The method as claimed in claim 22, wherein at least one passive safety function is activated at the intervention time of the actuator system.

32. A method for operating a vehicle having a collision avoidance system, the method comprising:
sensing a potential other party to a collision;
evaluating a risk of a collision between the vehicle and the other party; and
activating an actuator system to predefine a setpoint trajectory of the vehicle to avoid a lateral collision, if the other party to a collision comes relatively close in a lateral direction.

33. A device for operating a vehicle having a collision avoidance system comprising:
a sensor for sensing a potential other party to a collision;
an evaluator for evaluating a risk of a collision; and
an actuator system that is activatable to predefine a setpoint trajectory to avoid a lateral collision, if the other party to a collision comes relatively close in a lateral direction.
